(19) United States
(12) Patent Application Publication
(10) Pub. No.: US 2008/0313582 A1
(43) Pub. Date: Dec. 18, 2008

(54) Accurate Transistor Modeling

(75) Inventor: Samir Elias EL RAI, Colorado Springs, CO (US)

Correspondence Address: SCHWEGMAN, LUNDBERG & WOESSNER / ATMEL, P.O. BOX 2938, MINNEAPOLIS, MN, 55402, US

(73) Assignee: Atmel Corporation, San Jose, CA (US)

(21) Appl. No.: 11/763,301

(22) Filed: Jun. 14, 2007

(51) Int. Cl. G06F 17/50

(52) U.S. Cl. 716/4; 703/14

(57) ABSTRACT

A method and system for generating transistor models. In one embodiment, the method includes generating a transistor model that characterizes a topology of a circuit, and characterizes at least one coupling or at least one interaction between at least two transistors of the circuit.

### FIELD OF THE INVENTION

The present invention relates to integrated circuits, and more particularly to a method and system for transistor modeling.

### BACKGROUND OF THE INVENTION

Transistor modeling is well known. Transistor modeling is used to predict the behavior of a transistor in a circuit. Typically, the nodes of a given transistor are measured during the operation of the transistor in order to characterize the electrical behavior of the transistor. Because multiple transistors are used in typical circuits, the measurements for one transistor may be assumed for all of the transistors of a given circuit, because manually measuring each of the individual transistor would be tedious, error prone, and expensive. A problem with conventional solutions is that the resulting or realized circuit based on a given transistor model may be very inaccurate if errors are introduced into the modeling or if incorrect assumptions are made about transistors that not actually measured. Accordingly, what is needed is an improved method and system for transistor modeling. The present invention addresses such a need.

### SUMMARY OF THE INVENTION

A method and system for modeling transistors are disclosed. In one embodiment, the method includes generating a transistor model that characterizes a topology of a circuit, and characterizes at least one coupling or at least one interaction between at least two transistors of the circuit. According to the method and system disclosed herein, the transistor model accurately characterizes a circuit having two or more transistors.

### BRIEF DESCRIPTION OF THE DRAWINGS

FIG. 1 is a block diagram of a transistor modeling system in accordance with one embodiment.

FIG. 2 is a schematic diagram of a transistor model in accordance with one embodiment.

FIG. 3 is a technological cross-section of the transistor of FIG. 2.

FIG. 4 is a schematic diagram of a transistor model representing a differential amplifier, in accordance with one embodiment.

FIG. 5 is a technological cross-section of the differential amplifier of FIG. 4, in accordance with one embodiment.

FIG. 6 shows a cross-section diagram of a differential amplifier, in accordance with another embodiment.

FIG. 7 shows a cross-section diagram of a circuit, in accordance with another embodiment.

FIG. 8 shows a cross-section diagram of a circuit, in accordance with another embodiment.

FIG. 9 shows a cross-section diagram of a differential common-collector amplifier, in accordance with another embodiment.

FIG. 10 shows a cross-section diagram of a differential common-collector amplifier, in accordance with another embodiment.

FIG. 11 shows a cross-section diagram of a circuit, in accordance with another embodiment.

FIG. 12 is a flow chart showing a method for modeling transistors in accordance with one embodiment of the present invention.

FIG. 13 shows an example screenshot of a user interface or library browser 1300.

FIG. 14 shows an example screenshot of a window showing a transistor model.

FIG. 15 shows an example screenshot of a user interface or window used for modifying parameter values.

FIG. 16 shows an example screenshot of a user interface or window used for selecting parameter values.

FIG. 17 shows an example symbol of a differential transistor model.

FIG. 18 shows an example symbol of a common-emitter differential transistor model.

FIG. 19 shows an example symbol of a common-collector differential transistor model.

FIG. 20 shows an example symbol of a common-base differential transistor model.

FIG. 21 shows an example layout view of a transistor model of an NMOS transistor having one finger.

FIG. 22 shows an example layout view of a transistor model of a differential transistor having two fingers.

FIG. 23 shows an example layout view of a transistor model of an interdigital differential transistor having multiple fingers.

FIG. 24 shows an example layout view of a transistor model of a differential transistor having a guard or substrate ring.

### DETAILED DESCRIPTION OF THE INVENTION

The present invention relates to integrated circuits, and more particularly to a method and system for transistor modeling. The following description is presented to enable one of ordinary skill in the art to make and use the invention, and is provided in the context of a patent application and its requirements. Various modifications to the preferred embodiment and the generic principles and features described herein will be readily apparent to those skilled in the art. Thus, the present invention is not intended to be limited to the embodiments shown, but is to be accorded the widest scope consistent with the principles and features described herein.

A method and system in accordance with the present invention for modeling transistors are disclosed. The method includes generating a transistor model that characterizes a topology of a circuit and characterizes at least one coupling and/or at least one interaction between at least two transistors of the circuit. As a result, the transistor model accurately characterizes a circuit having two or more transistors. To more particularly describe the features of the present invention, refer now to the following description in conjunction with the accompanying figures.

Although the present invention disclosed herein is described in the context of CMOS transistors, the present invention may apply to other types of transistors such as bipolar transistors, etc., and still remain within the spirit and scope of the present invention.

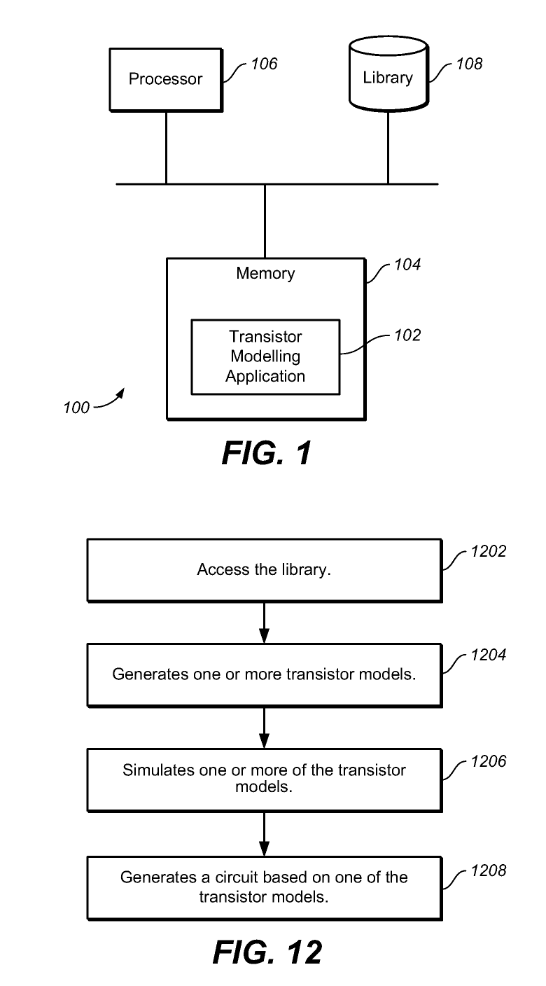

FIG. 1 is a block diagram of a transistor modeling system 100 in accordance with one embodiment. As FIG. 1 shows, the transistor modeling system 100 includes a transistor modeling application 102 stored in a memory 104, a processor 106 for executing the transistor modeling application 102, and a library 106 for parameter values and for storing transistor models.

In operation, the transistor modeling application of the transistor modeling system generates a transistor model that describes a topology of a circuit and describes a coupling and/or at least one interaction between at least two transistors of the circuit.

In one embodiment, the library includes a database of parameter values associated with single transistors and parameter values associated with groups of two or more transistors coupled together. The parameter values may include values representing a number of transistors in a given circuit, a number of fingers for each transistor of a given circuit, scattering parameters (S-parameters), etc.

S-parameters are a set of parameters that characterize high-frequency transistors and describe electrical characteristics such as parasitic capacitance, large signal behavior, small signal behavior, temperature behavior, noise factors, impedance, gain, loss, and reflection coefficient, etc. For example, the parameter values may include any parasitic capacitance that may be associated with one gate of one transistor and another gate of another transistor. The library 108 may include other parameter values such as current, transconductance, capacitance, noise coupling, capacitive coupling between the substrate, capacitive coupling between the gates, etc.

In one embodiment, the parameter values include values at different direct current (DC) voltages, DC currents, gate lengths, gate widths, etc. In another embodiment, the parameter values include values based on the number of fingers for an individual transistor or based on the number of fingers for each transistor for a group of transistors. In one embodiment, the parameter values may also be based on the type of transistors, the number of transistors, the distance (5 um, 10 um, 15 um, etc.) between two or more transistors, etc. The parameter values may also be based on the type of circuit. For example, a circuit may include single-ended transistors and/or differential circuits, such as an amplifier, a power amplifier driver, a local oscillator (VCO), a converter, etc. As such, the parameter values of a given node may depend on one or more of the above described variables. The following figures provide more examples.

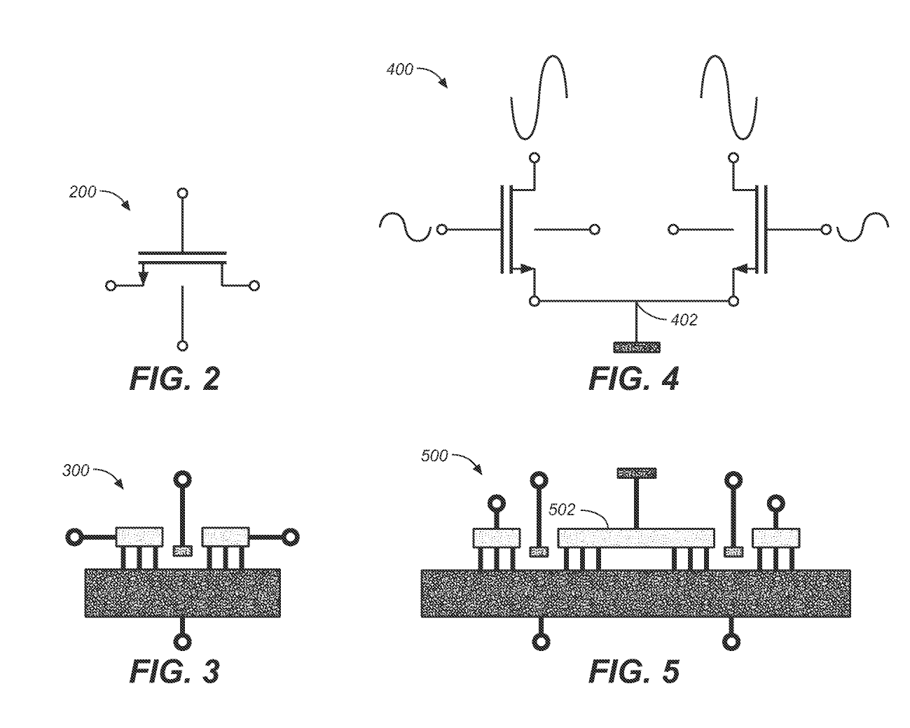

FIG. 2 is a schematic diagram of a transistor model 200 in accordance with one embodiment. A transistor may be an NMOS transistor, a PMOS transistor, or an NPN transistor. In the example shown, the transistor 200 is a NMOS transistor. As described above, the library 108 stores parameter values associated with each of the nodes of the transistor. FIG. 3 is a technological cross-section diagram of the transistor 200 of FIG. 2. The transistor 200 may be used in single-ended circuits and also in differential circuits.

FIG. 4 is a schematic diagram of a transistor model 400 representing a differential amplifier, in accordance with one embodiment. As FIG. 4 shows, the transistor model 400 includes a group of two transistors, and the two transistors share the same source 402. Transistors may share other nodes, such as the same gate, drain, emitter, collector, base, etc. For ease of illustration, only two transistors are shown. The transistor model 400 may include more that two transistors. As FIG. 4 shows, the input signals may be symmetrical signals with 180 degree phase shifting. Also, the output signals may be symmetrical having 180 degree phase shifting relative to each other.

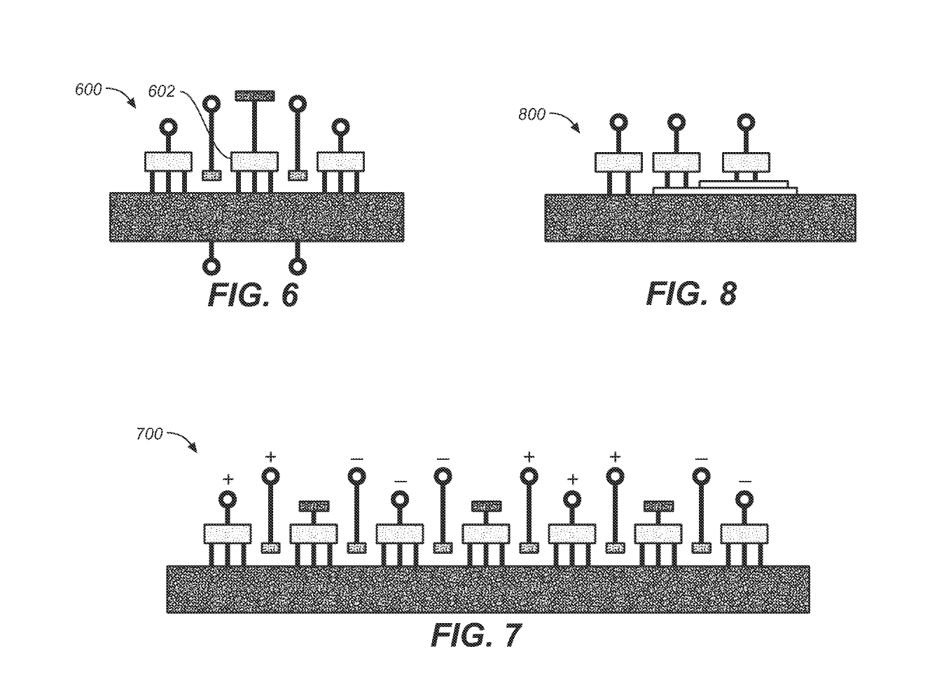

FIG. 5 is a technological cross-section of the differential amplifier 400 of FIG. 4, in accordance with one embodiment. In some embodiments, the connection 402 (e.g., drain) between both transistors should be as short as possible in order to realize a high differential gain. It is also important to make the distance between the two transistors as small as possible in order to get proper matching between both transistors. FIG. 6 shows a cross-section diagram of a differential amplifier 600, in accordance with another embodiment. As FIG. 6 shows, the length of the connection 602 between the transistors is minimized in order to achieve a high differential gain and proper matching. If parameter values of an individual transistor were used to simulate a circuit such as the different amplifier 600, the results may not be very accurate, because the parameter value would not take into account the coupling and the interaction between both transistors. Also, the length of the connection 602 would not be taken into account. As described above, the library 108 includes parameter values not only for transistor models of individual transistors but also for groups of two or more transistors. As described above, the parameter values characterize each node with respect to varying DC voltages, DC currents, gate lengths, gate widths, etc.

In one embodiment, the parameter values also characterize each node based on varying distances between transistors. As such, the parameter values for the nodes of the differential amplifier 400 may be different from the parameter values for the nodes of the differential amplifier 600, because the distances between their respective transistors (e.g., connections 402 and 602) are different. Accordingly, transistor models describing respective differential amplifiers 400 and 600 would be accurate, since each transistor model utilizes accurate parameter values. This accuracy becomes more advantageous with smaller technologies (e.g., 130 nm and 90 nm). Accordingly, the parameter values accommodate scalable circuits having different spacing requirements. As such, embodiments of the present invention increase the accuracy of transistor models, because the parameter values and the resulting transistors models based on those parameter values describe various topologies that include various couplings and interactions between two more transistors, especially in a differential mode. Using an independent transistor model for every transistor would otherwise neglect the couplings and interactions between these transistors.

FIG. 7 shows a cross-section diagram of a circuit 700, in accordance with another embodiment. FIG. 7 shows a multi-finger configuration, where the “+” signs indicate signals with a 0 degree phase shift, and the “−” signs indicate signals with 180 degree phase shift. The library 108 stores parameter variables for nodes of various transistor topologies such as the circuit 700. The library 108 stores parameter values for other types of transistors as well, illustrated in the following figures.

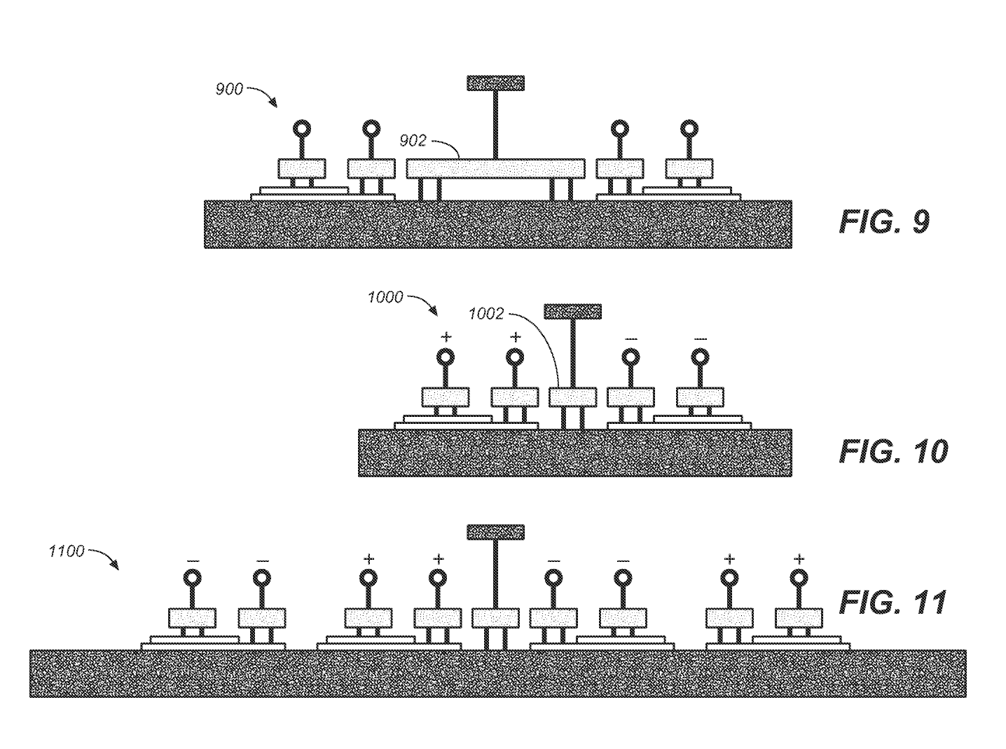

FIG. 8 shows a cross-section diagram of a circuit 800, in accordance with another embodiment. FIG. 8 shows an NPN bipolar transistor. The same situation as described above with respect to the length of the connections 502 and 602 of FIGS. 5 and 6 exists for bipolar transistors, as illustrated in FIGS. 9 and 10 below.

FIG. 9 shows a cross-section diagram of a differential common-collector amplifier 900, in accordance with another embodiment. FIG. 10 shows a cross-section diagram of a differential common-collector amplifier 1000, in accordance with another embodiment. As FIGS. 9 and 10 show, the length of the connection 1002 of the differential common-collector amplifier 1000 is shorter than the length of the connection 902 of the differential common-collector amplifier 900. As such, differential common-collector amplifier 1000 has a higher performance. Furthermore, the parameter values for the nodes of the differential common-collector amplifier 1000 will be different from the parameter values for the nodes of the differential common-collector amplifier 900.

FIG. 11 shows a cross-section diagram of a circuit 1100, in accordance with another embodiment. This transistor topology has more fingers and even smaller spacing than that of FIG. 10. Accordingly, the parameter values of corresponding to the nodes of the circuit 110 will be unique to such a topology, and will thus be very accurate.

The following FIG. 12 describes a process flow for utilizing the library 108 for generating transistor models based on the various parameter values described above.

FIG. 12 is a flow chart showing a method for modeling transistors in accordance with one embodiment of the present invention. Referring to both FIGS. 1 and 12 together, the process begins in step 1202 where the transistor modeling application accesses the library. As described above, the parameter values may include values representing the number of transistors in a given circuit, the number of fingers for each transistor of a given circuit, as well as S-parameters, and these parameter values may apply to both individual transistors as well as groups of two or more transistors.

Next, if the transistor modeling application does not access the library in step 1202, the transistor modeling application may generate one or more transistor models that describe a topology of a circuit and describe at least one coupling and/or at least one interaction between at least two transistors of the circuit, in step 1204. In one embodiment, the transistor modeling application utilizes the parameter values stored in the library to generate each transistor model. In one embodiment, each model may characterize a single transistor, and may also characterize groups of two or more transistors coupled together. In particular embodiments, the transistor model may characterize both differential circuits and single-ended circuits, such as those described above. The transistor modeling application may then store the one or more transistor models in the library or other suitable storage location for future access (e.g., by a user).

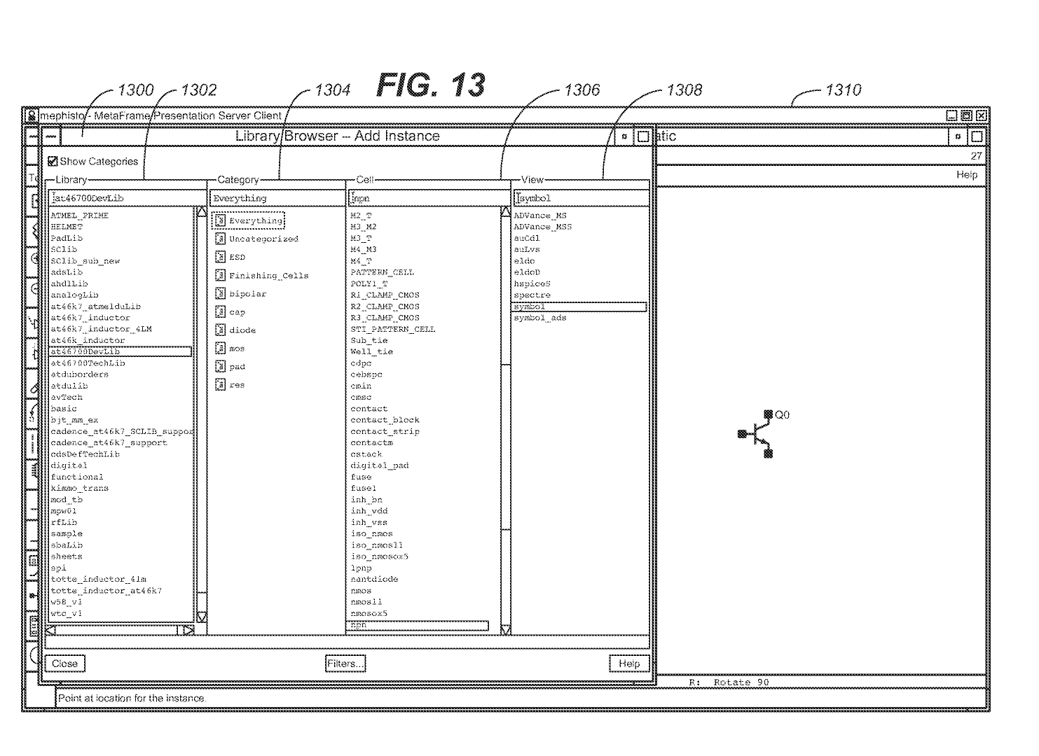

FIG. 13 shows an example screenshot of a user interface or library browser 1300. As FIG. 13 shows, the library browser 1300 may include several selection categories. For example, selection categories may include a library selection 1302, a circuit element selection 1304 (labeled “category” in this specific example), a cell selection 1306, and a view selection 1308. In the specific example shown in FIG. 13, a library labeled “at46700DevLib” is selected, an “everything” selection in circuit element selection 1306 is selected, an “npn” transistor is selected, and a “symbol” view is selected. In one embodiment, the results of the selections may be displayed in a window such as window 1310. In this example, window 1310 displays a symbol of an NPN transistor.

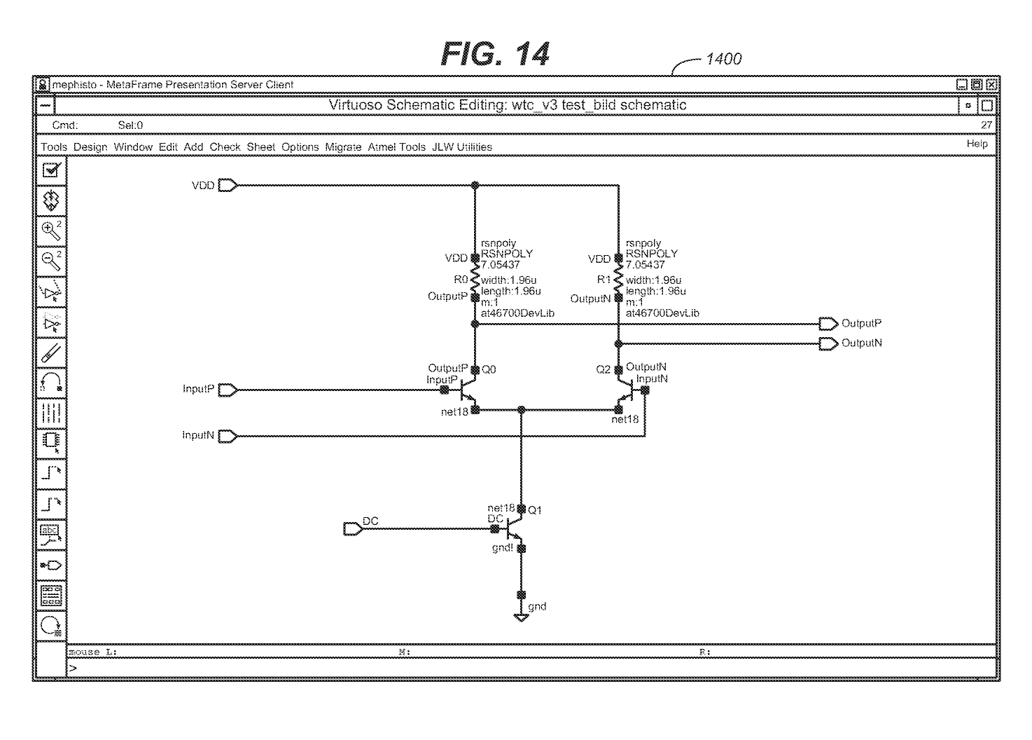

A user may continue this selection process and create the circuit shown in FIG. 14 until a transistor model describing a desired circuit is complete. FIG. 14 shows an example screenshot of a window 1400 showing a transistor model. This example transistor model includes three transistors and two resistors. In one embodiment, the transistors may be based on single-ended modeling. In one embodiment, the two mirroring transistors may be used to model a common-emitter differential transistor model such as the common-emitter differential transistor model 1800 shown in FIG. 18 below. In particular embodiments, a given transistor model may characterize passive and active networks. In particular embodiments, a given transistor model may couple to passive and active networks. Passive networks may include, for example, capacitors, resistors, etc. Active networks may include, for example, diode networks, etc.

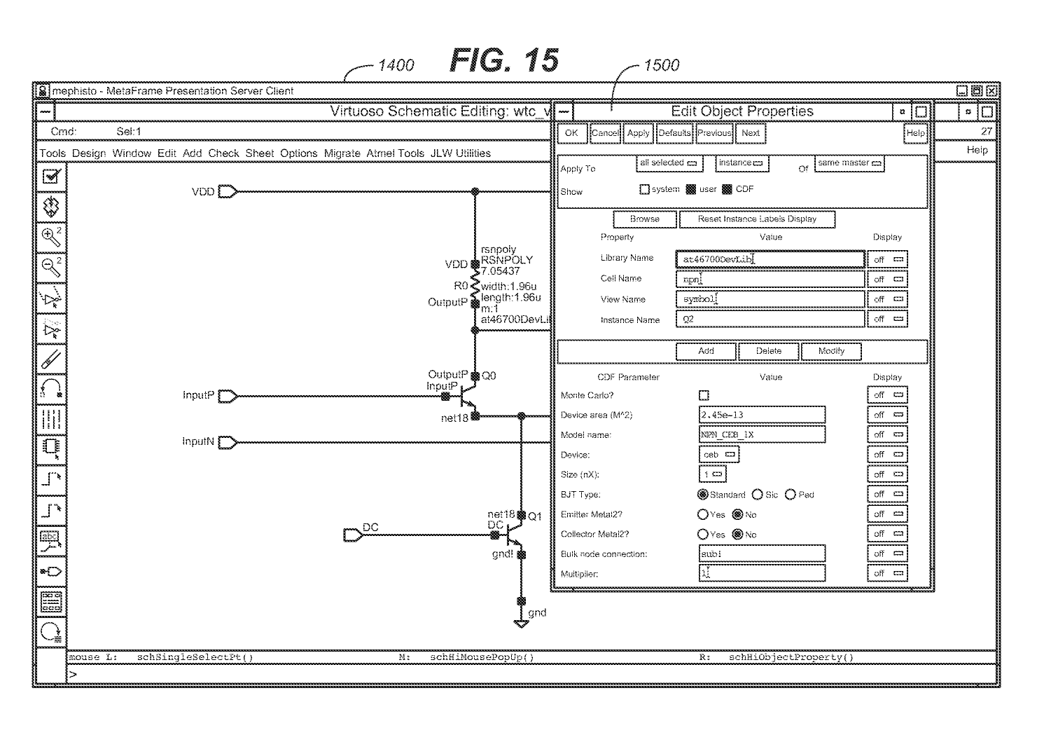

In one embodiment, a user may modify parameter values of a circuit of a given transistor model as desired in order to modify or fine tune the transistor model. FIG. 15 shows an example screenshot of a user interface or window 1500 used for modifying parameter values. FIG. 15 shows the window 1500 overlaying the window 1400 of FIG. 14. In particular embodiments, the window 1500 allows a user to modify various parameter values such as device area, device type, device size, etc. Modifying other parameters values is possible such as those parameter values shown in FIG. 15 and other parameter values not shown in FIG. 15.

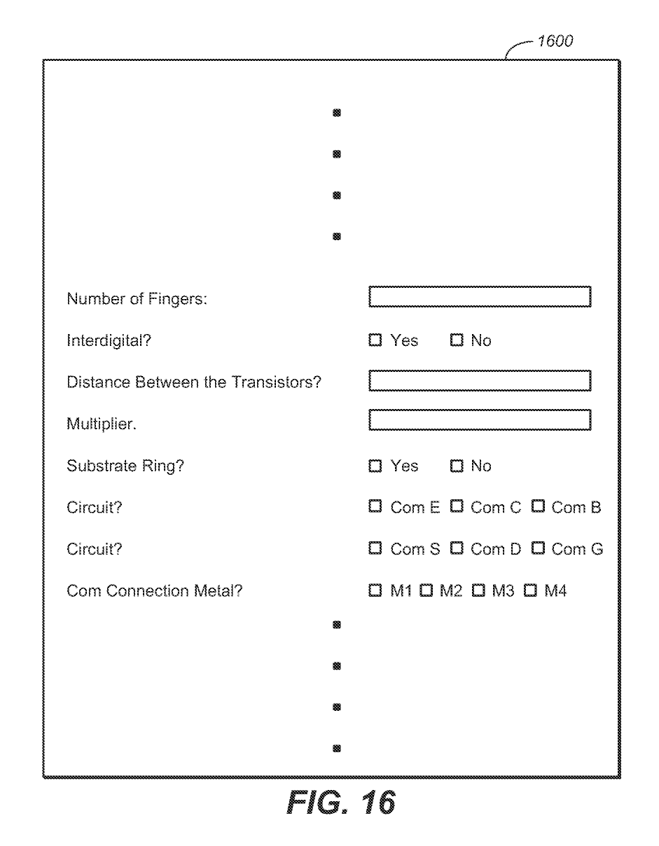

FIG. 16 shows an example screenshot of a user interface or window 1600 used for selecting parameter values. As FIG. 16 shows, a user may indicate various parameter values to be added or modified in relation to a given transistor model. For example, for a given new transistor model, the user may select the number of figures of one or more device elements. A user may designate whether one or more device elements are interdigital. For example, within a group of coupled transistors, some transistors may be used for positive signals and some transistors may be used for negative signals. FIGS. 7, 10, and 11 described above are examples of interdigital circuits. As FIG. 16 shows, a user may also indicated the distance between transistors, a multiplier, whether a substrate ring is use, whether there is a substrate ring, whether a given set of transistors shares common nodes (e.g., common emitter/collector/base for bipolar transistors, common source/drain/gate for CMOS transistors, etc.), whether a given set of transistors shares common metal layers (e.g., metal 1/2/3/4/etc.), etc. Other parameters values are possible.

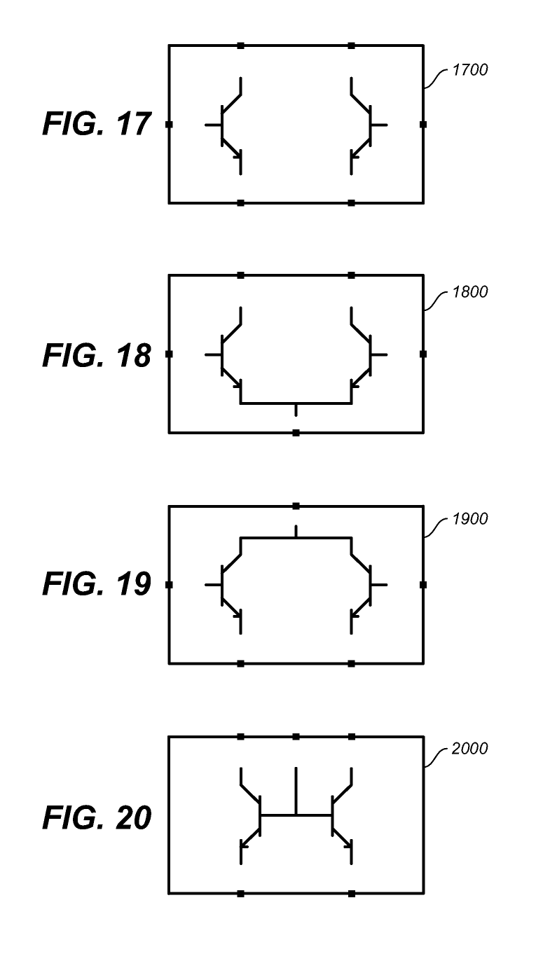

FIGS. 17-20 show example symbol views of different transistor models in accordance with several embodiments of the present invention. FIG. 17 shows an example symbol of a differential transistor model 1700. FIG. 18 shows an example symbol of a common-emitter differential transistor model 1800. FIG. 19 shows an example symbol of a common-collector differential transistor model 1900. FIG. 20 shows an example symbol of a common-base differential transistor model 2000.

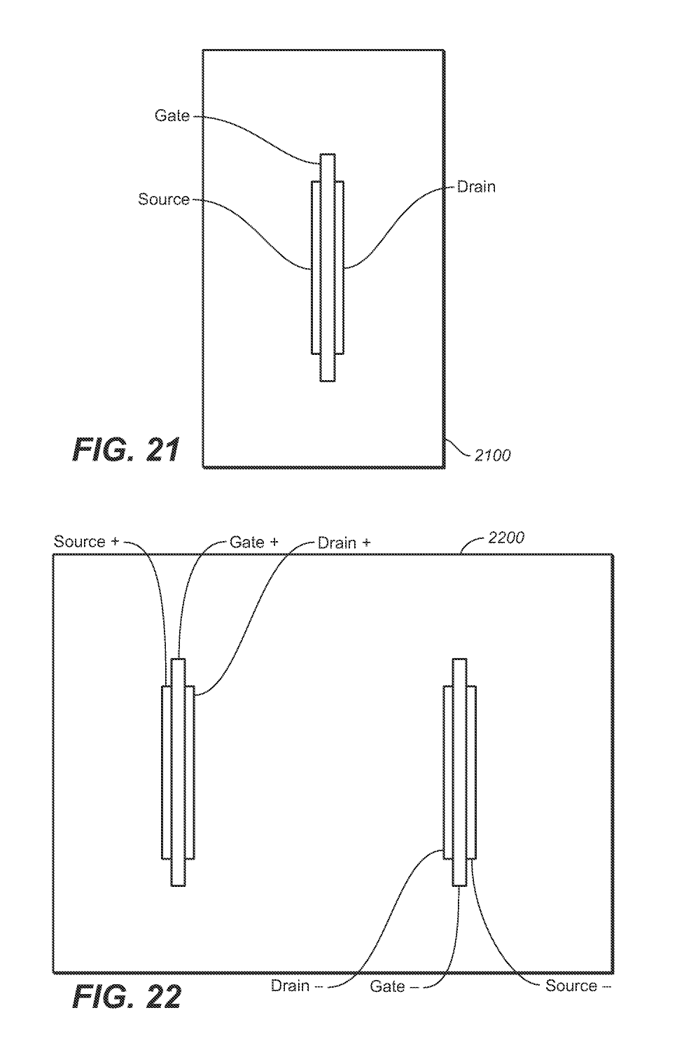

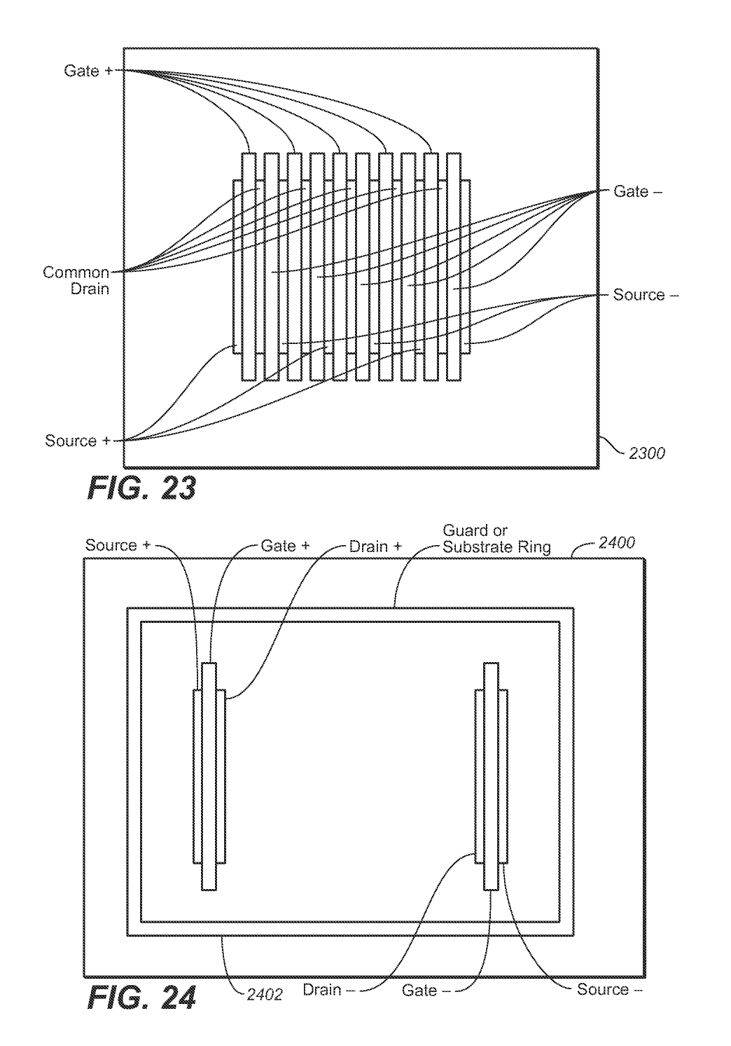

FIGS. 21-23 show example layout views of a different transistor models in accordance with several embodiments of the present invention. FIG. 21 shows an example layout view of a transistor model 2100 of an NMOS transistor having one finger. FIG. 22 shows an example layout view of a transistor model 2200 of a differential transistor having two fingers. FIG. 23 shows an example layout view of a transistor model 2300 of an interdigital differential transistor having multiple fingers. Other transistor models are possible in addition to these examples.

FIG. 24 shows an example layout view of a transistor model 2400 of a differential transistor having a guard or substrate ring 2402.

Referring again to FIG. 12, in step 1206, the transistor modeling application simulates one or more of the transistor models such as those examples described above. Because a given transistor model describes the interactions at nodes coupling two or more transistors, the simulated circuit will more accurately predict how a physical realization of the circuit will operate. For example, the transistor models described in FIGS. 17-20 will each produce different results, because their nodes are coupled differently and the interactions between their respective transistors are different. Similarly, transistor models described herein in accordance with other embodiments will produce different results. For example, each distance between two given transistors may describe a match or mismatch between two transistors. Such interactions between the transistors would be available for a designer to determine whether the particular parameters would be acceptable or not. In step 1208, the transistor modeling application generates a circuit based on one or more of the transistor models. By utilizing the parameter values stored in the library 108, the simulation will have produced results that accurately model the measured characteristics of the physical realization.

According to the system and method disclosed herein, the present invention provides numerous benefits. For example, embodiments of the present invention provide accurate transistor models not only for single transistors but also for groups of two or more transistors coupled together. Also, the transistor models are based on parameter values that characterize nodes of not only individual transistors but also nodes shared by two or more transistors. As such, the resulting transistor models accurately describe interactions between two or more transistors. Embodiments of the present invention also provide transistor models for both single-ended circuits and for differential circuits.

A method and system in accordance with the present invention for modeling transistors has been disclosed. The method includes generating a transistor model that characterizes a topology of a circuit and characterizes at least one coupling and/or at least one interaction between at least two transistors of the circuit. As a result, the transistor model accurately characterizes a circuit having two or more transistors.

The present invention has been described in accordance with the embodiments shown. One of ordinary skill in the art will readily recognize that there could be variations to the embodiments, and that any variations would be within the spirit and scope of the present invention. For example, embodiments of the present invention may be implemented using hardware, software, a computer-readable medium containing program instructions, or a combination thereof. Software written according to the present invention or results of the present invention may be stored in some form of computer-readable medium such as memory, hard drive, CD-ROM, DVD, or other media for subsequent purposes such as being executed or processed by a processor, being displayed to a user, etc. Also, software written according to the present invention or results of the present invention may be transmitted in a signal over a network. In some embodiments, a computer-readable medium may include a computer-readable signal that may be transmitted over a network. Accordingly, many modifications may be made by one of ordinary skill in the art without departing from the spirit and scope of the appended claims.

What is claimed is:

1. A method comprising:
generating a transistor model that characterizes a topology of a circuit and characterizes at least one coupling or at least one interaction between at least two transistors of the circuit.

2. The method of claim 1 further comprising:
accessing a library, wherein the library comprises parameter values associated with single transistors and parameter values associated with groups of at least two transistors coupled together.

3. The method of claim 2 wherein the parameter values comprise a value representing a number of transistors in the circuit.

4. The method of claim 2 wherein the parameter values comprise a value representing a number of fingers for each transistor of the circuit.

5. The method of claim 2 wherein the parameter values comprise scattering parameters (S-parameters).

6. The method of claim 5 wherein the S-parameters characterize a transistor and describe electrical characteristics of the transistor.

7. The method of claim 5 wherein the S-parameters comprise at least one of parasitic capacitance, large signal behavior, small signal behavior, temperature behavior, noise factors, impedance, gain, loss, and reflection coefficient.

8. The method of claim 1 wherein the transistor model characterizes a differential circuit.

9. The method of claim 1 wherein the transistor model characterizes a single-ended circuit.

10. The method of claim 1 further comprising simulating the transistor model.

11. The method of claim 1 further comprising generating a circuit based on the transistor model.

12. A computer-readable medium containing program instructions which when executed by a computer system cause the computer system to execute a method comprising:
generating a transistor model that characterizes a topology of a circuit and characterizes at least one coupling or at least one interaction between at least two transistors of the circuit.

13. The computer-readable medium of claim 12 further comprising program instructions for accessing a library, wherein the library comprises parameter values associated with single transistors and parameter values associated with groups of at least two transistors coupled together.

14. The computer-readable medium of claim 13 wherein the parameter values comprise a value representing a number of transistors in the circuit.

15. The computer-readable medium of claim 12 wherein the parameter values comprise S-parameters.

16. The computer-readable medium of claim 12 wherein the transistor model characterizes a differential circuit.

17. The computer-readable medium of claim 12 wherein the transistor model characterizes a single-ended circuit.

18. The computer-readable medium of claim 12 further comprising program instructions for simulating the transistor model.

19. The computer-readable medium of claim 12 further comprising program instructions for generating a circuit based on the transistor model.

20. A system comprising:
a processor; and
a library coupled to the processor, wherein the processor is operable to access library to generate a transistor model that characterizes a topology of a circuit, and characterizes at least one coupling or at least one interaction between at least two transistors of the circuit.

21. The system of claim 20 wherein the library comprises parameter values associated with single transistors and parameter values associated with groups of at least two transistors coupled together.

22. The system of claim 20 wherein the parameter values comprise S-parameters.

23. The system of claim 20 wherein the transistor model may characterize a passive network.

24. The system of claim 20 wherein the transistor model may characterize an active network.
